(19) United States
(12) Patent Application Publication
(10) Pub. No.: US 2018/0191184 A1
(43) Pub. Date: Jul. 5, 2018

(54) STYLUS AND HOLDER TO FACILITATE RECHARGING OF STYLUS

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JUN-WEI YANG, Shenzhen (CN)

(21) Appl. No.: 15/705,395

(22) Filed: Sep. 15, 2017

(30) Foreign Application Priority Data
Dec. 30, 2016 (CN) 201621491271.2

(51) Int. Cl. H02J 7/00; H01R 13/22; G06F 3/039; G06F 3/0354

(52) U.S. Cl. CPC H02J 7/0044; H01R 13/22; G06F 3/03545; G06F 3/039; H02J 7/0052

(57) ABSTRACT

A stylus and holder assembly to facilitate recharging includes a stylus and a holder. The holder includes a connecting portion, a holding portion, a charging port, and a charging circuit. The holding portion is attached to the connecting portion for holding the stylus. The charging port is disposed in the holding portion. The charging circuit is disposed in the connecting portion, and is electrically connected to the charging port. The stylus can be recharged by the charging circuit through the charging port when required, when in place in the holding portion of the holder.

### CROSS REFERENCE TO RELATED APPLICATION

This application claims priority to Chinese Patent Application No. 201621491271.2, filed Dec. 30, 2016, the disclosure of which is incorporated herein by reference in its entirety.

This application has subject matter similar to U.S. patent application Ser. No. 15/688,861, filed Aug. 28, 2017, the disclosure of which is incorporated herein by reference in its entirety.

### FIELD

The present disclosure relates to an electrically powered stylus and holder to facilitate recharging of the stylus.

### BACKGROUND

Smartphones, tablets, PDAs, and other portable electronic devices are popular. Many electronic devices are equipped with a stylus to assist data entry. However, the stylus must be inserted into a charging port of the electronic device when the stylus needs to be recharged.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic front view in partial section of a stylus and holder assembly.

FIG. 2 is a schematic front view of stylus of FIG. 1.

FIG. 3 is a schematic front view of holder of FIG. 1.

FIG. 4 is a block diagram of the stylus and holder assembly of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

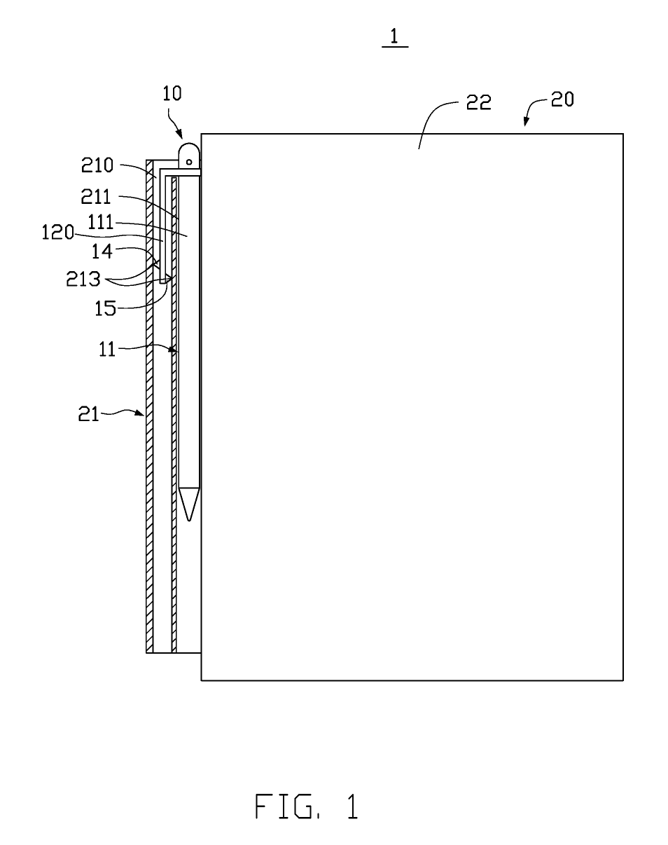

With reference to FIG. 1, an exemplary embodiment of a stylus and holding assembly (holder assembly 1) includes a stylus 10 and a holder 20.

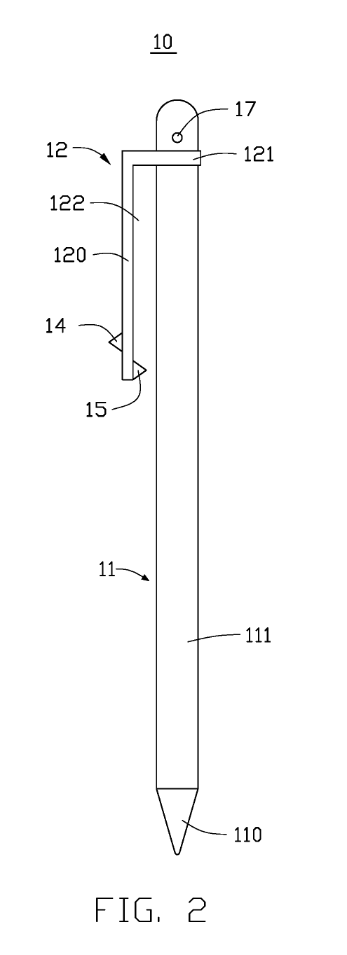

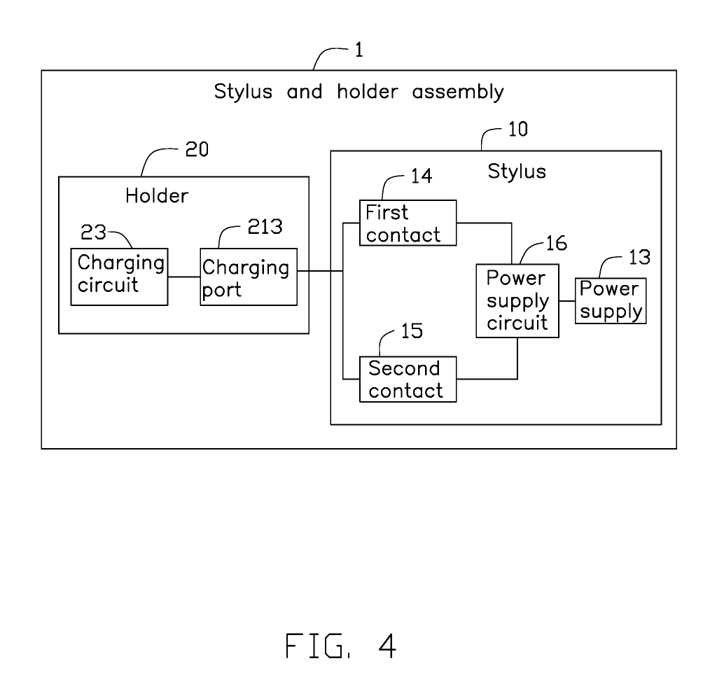

With reference to FIG. 2, the stylus 10 includes a body 11 and a clip 12. The clip 12 is mounted on the body 11 for secure holding in a pocket or the like. With reference to FIG. 4, the stylus 10 further includes a power supply 13 being contained in body 11 (and only schematically shown), a first contact 14, and a second contact 15. The power supply 13 is mounted in the body 11 for supplying power to the body 11. The power supply 13 may be a rechargeable lithium battery. The first contact 14 and the second contact 15 are provided on the clip 12.

In the present exemplary embodiment, the stylus 10 further includes a power supply circuit 16 mounted in the body 11. The power supply circuit 16 is electrically connected to the first contact 14, the second contact 15, and the power supply 13 such that the first contact 14 and the second contact 15 can be electrically connected to the power supply 13 through the power supply circuit 16.

With reference to FIG. 2, in the present exemplary embodiment, the body 11 is made of an insulating material, and the body 11 has a cylindrical tube 111 and a tapered tip 110. The tube 111 has a bottom end and a top end. The tip 110 is attached to the bottom end of the tube 111. The clip 12 is L-shaped, and has a securing portion 121 and a gripping portion 120. The securing portion 121 and the gripping portion 120 are perpendicular to each other. The securing portion 121 is mounted on the top end of the tube 111. The gripping portion 120 has an inner surface and an outer surface. The inner surface of the gripping portion 120 is spaced from an outer surface of the tube 111, thereby forming a gripping space 122 therebetween. The first contact 14 is provided on the outer surface of the gripping portion 120. The second contact 15 is provided on the inner surface of the gripping portion 120. The first contact 14 and the second contact 15 are telescopic.

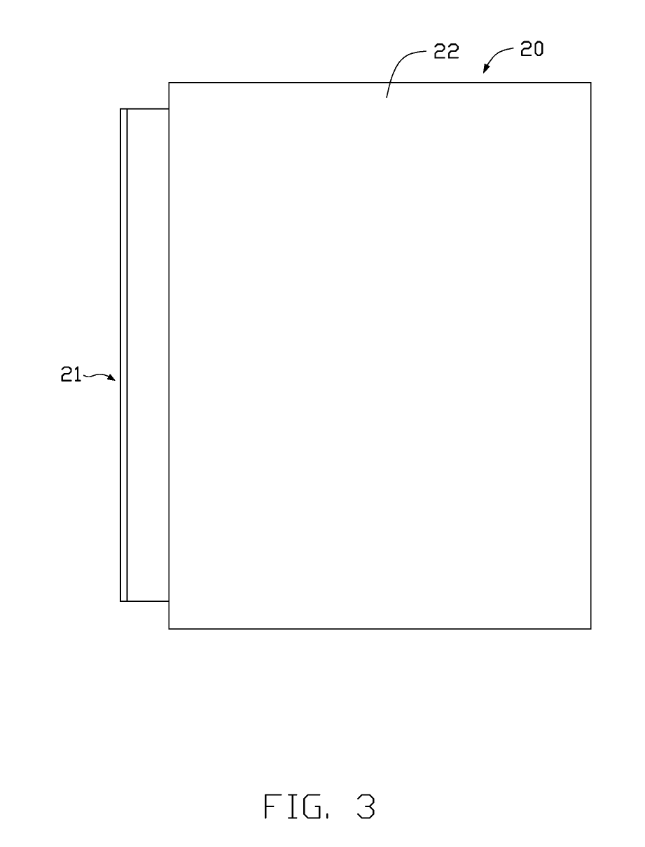

With reference to FIGS. 1 and 3, the holder 20 includes a connecting portion 22 and a holding portion 21. The connecting portion 22 is configured to connect to an electronic device. The connecting portion 22 may be a keyboard or a protective cover. The electronic device may be a smartphone, tablet, PDA, or other portable electronic device. The holding portion 21 is attached to a side of the connecting portion 22 for holding the stylus 10 when not in use.

In the present exemplary embodiment, the holding portion 21 is cylindrical and has a main holding chamber 211 and an auxiliary holding chamber 210. The holding portion 21 is made of an elastic material. The main holding chamber 211 has an inner diameter smaller than an outer diameter of the tube 111 of the body 11 of the stylus 10. The main holding chamber 211 receives the body 11 of the stylus 10, and the auxiliary holding chamber 210 receives the gripping portion of the clip 12 of the stylus 10.

In the present exemplary embodiment, the holding portion 21 further has two guide grooves (not shown) and two charging ports 213. The guide grooves are formed on an inner surface of the auxiliary holding chamber 210, and one charging port 213 is disposed on an end of a different one guide groove. The guide grooves can guide the first contact 14 and the second contact 15 of the stylus 10 to contact the charging ports 213.

With further reference to FIG. 4, in the present exemplary embodiment, the holder 20 further includes a charging circuit 23 mounted in the connecting portion 22. The charging circuit 23 is electrically connected to the charging ports 213. The charging circuit 23 can be electrically connected to the power supply 13 of the stylus 10 through the charging ports 213, the first contact 14, the second contact 15, and the power supply circuit 16, to recharge the power supply 13.

In other exemplary embodiments, the first contact 14 is a ground contact for preventing leakage of electricity when the stylus 10 is recharged, and the second contact 15 is a positive contact.

With reference to FIG. 2, in the present exemplary embodiment, the stylus 10 further includes an indicator light 17. The indicator light 17 is mounted on the body 11 adjacent to the clip 12 for indicating a charge status of the stylus 10. The indicator light 17 emits a first color light, e.g., red light, when the charging circuit 23 of the holder 20 is recharging the power supply 13 of the stylus 10, and the indicator light 17 emits a second color light, e.g., green light, when recharging electricity is not required by the power supply 13 of the stylus 10. The indicator light 17 may be an LED light. Instead of different colors, different blinking sequences can be used to indicate the status of the charging process.

The exemplary embodiments shown and described above are only examples. Many details are often found in the art such as the other features of a stylus and holder assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A holder comprising:
a connecting portion;
a holding portion attached to the connecting portion;
a charging port disposed in the holding portion; and
a charging circuit disposed in the connecting portion, and electrically connected to the charging port;
wherein the holding portion is used to hold a stylus, and the charging circuit is used to recharge the stylus through the charging port.

2. The holder of claim 1, wherein the holding portion has a main holding chamber and an auxiliary holding chamber, the main holding chamber is used to receive a body of the stylus, and the auxiliary holding chamber is used to receive a clip of the stylus.

3. The holder of claim 2, wherein two charging ports are positioned on an inner surface of the auxiliary holding chamber.

4. The holder of claim 1, wherein the holding portion is made of an elastic material.

5. The holder of claim 2, wherein the holding portion is made of an elastic material.

6. The holder of claim 3, wherein the holding portion is made of an elastic material.

7. The holder of claim 1, wherein the holding portion is cylindrical.

8. The holder of claim 2, wherein the holding portion is cylindrical.

9. The holder of claim 3, wherein the holding portion is cylindrical.

10. The holder of claim 4, wherein the holding portion is cylindrical.

11. A stylus and holder assembly comprising:
a stylus; and
a holder comprising:
a connecting portion;
a holding portion attached to the connecting portion;
a charging port disposed in the holding portion; and
a charging circuit disposed in the connecting portion, and electrically connected to the charging port;
wherein the holding portion is used to hold the stylus, and the charging circuit is used to recharge the stylus through the charging port.

12. The stylus and holder assembly of claim 11, wherein the holding portion has a main holding chamber and an auxiliary holding chamber, the main holding chamber is used to receive a body of the stylus, and the auxiliary holding chamber is used to receive a clip of the stylus.

13. The stylus and holder assembly of claim 12, two charging ports are positioned on an inner surface of the auxiliary holding chamber.

14. The stylus and holder assembly of claim 11, wherein the holding portion is made of an elastic material.

15. The stylus and holder assembly of claim 12, wherein the holding portion is made of an elastic material.

16. The stylus and holder assembly of claim 13, wherein the holding portion is made of an elastic material.

17. The stylus and holder assembly of claim 11, wherein the holding portion is cylindrical.

18. The stylus and holder assembly of claim 12, wherein the holding portion is cylindrical.

19. The stylus and holder assembly of claim 13, wherein the holding portion is cylindrical.

20. The stylus and holder assembly of claim 14, wherein the holding portion is cylindrical.
